(19) United States
(12) Patent Application Publication
(10) Pub. No.: US 2023/0067628 A1
(43) Pub. Date: Mar. 2, 2023

(54) SYSTEMS AND METHODS FOR AUTOMATICALLY DETECTING AND AMELIORATING BIAS IN SOCIAL MULTIMEDIA

(71) Applicant: Toyota Research Institute, Inc., Los Altos, CA (US)

(72) Inventors: Scott Carter, San Jose, CA (US); Alexandre Filipowicz, Mountain View, CA (US); Rumen Iliev, Millbrae, CA (US)

(73) Assignee: Toyota Research Institute, Inc., Los Altos, CA (US)

(21) Appl. No.: 17/460,852

(22) Filed: Aug. 30, 2021

(51) Int. Cl. G06F 16/48; G06F 16/487; G06F 40/20; G06F 16/438

(52) U.S. Cl. CPC G06F 16/489; G06F 16/487; G06F 40/20; G06F 16/438

(57) ABSTRACT

In accordance with one embodiment of the present disclosure, a system includes a processor, a memory communicatively coupled to the processor, and machine-readable instructions stored in the memory. The machine-readable instructions, when executed by the processor, cause the processor to perform operations including receiving a multimedia file having a metadata and a text data, the multimedia file and the text data corresponding to a user. Operations also include determining a reliability status of the multimedia file based on the multimedia file, the text data, or combinations thereof. Operations further include determining a bias status of the user based on the multimedia file, the text data, or combinations thereof, and generating a report comprising the reliability status and the bias status of the multimedia file.

### TECHNICAL FIELD

The present disclosure relates to bias recognition, and more particularly to systems and methods for automatically detecting and ameliorating bias in social multimedia.

### BACKGROUND

Multimedia, such as photographs and videos, are now shared ubiquitously on social media and are often used in and of themselves to represent critical information about an event. Although multimedia provides impressions of the real world, multimedia can be utilized in such a way as to misinform a viewer about the event. Multimedia may misinform a viewer if the multimedia lacks reliability, such as when the multimedia does not accurately depict an event. For example, photographs can be framed in such a way as to make crowd size appear smaller or larger than actual crowd size, or to leave out other context. Furthermore, multimedia may misinform a viewer if it contributes to a known bias. That is, the poster of the multimedia may have a particular affect regarding a subject portrayed in the multimedia and the multimedia serves to invoke that affect in the viewer. For example, photographs can be selected for posting in such a way as to make the common subject of the photographs appear in a negative light in each photograph.

Current systems for detecting bias in social media typically focus on text content associated with multimedia content. However, text is often associated with images or videos to provide context and/or supplement the text. Because text content is the primary focus of bias detection systems, the corresponding multimedia often get ignored. Accordingly, the present disclosure provides a bias detection system for detecting and/or ameliorating user biases based on photos and/or videos.

Therefore, intelligent and automatic strategies for detecting and/or ameliorating biases in multimedia are desired.

### SUMMARY

In accordance with one embodiment of the present disclosure, a system includes a processor, a memory communicatively coupled to the processor, and machine-readable instructions stored in the memory. The machine-readable instructions, when executed by the processor, cause the processor to perform operations including receiving a multimedia file having a metadata and a text data, the multimedia file and the text data corresponding to a user. Operations also include determining a reliability status of the multimedia file based on the multimedia file, the text data, or combinations thereof. Operations further include determining a bias status of the user based on the multimedia file, the text data, or combinations thereof, and generating a report comprising the reliability status and the bias status of the multimedia file.

In accordance with another embodiment of the present disclosure, a method includes receiving a multimedia file having a metadata and a text data, the multimedia file and the text data corresponding to a user. The method also includes determining a reliability status of the multimedia file based on the multimedia file, the text data, or combinations thereof, The method further includes determining a bias status of the user based on the multimedia file, the text data, or combinations thereof, and generating a report comprising the reliability status and the bias status of the multimedia file.

Although the concepts of the present disclosure are described herein with primary reference to social media, it is contemplated that the concepts will enjoy applicability to any multimedia hosting environment. For example, and not by way of limitation, it is contemplated that the concepts of the present disclosure will enjoy applicability to news media, where text content is often accompanied with multimedia content.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts an example system for detecting and ameliorating bias in social multimedia, according to one or more embodiments shown and described herein;

FIG. 2 depicts an example user interface of a social multimedia post, according to one or more embodiments shown and described herein;

FIG. 3 depicts a flowchart of an example method for detecting and ameliorating bias in social multimedia, according to one or more embodiments shown and described herein;

FIG. 4 depicts a flowchart of an example method for determining a reliability status based on location, according to one or more embodiments shown and described herein;

FIG. 5 depicts a flowchart of an example method for determining a reliability status based on ownership, according to one or more embodiments shown and described herein;

FIG. 6 depicts a flowchart of an example method for determining a reliability status based on file manipulation, according to one or more embodiments shown and described herein;

FIG. 7 depicts a flowchart of an example method for determining a reliability status based on subject, according to one or more embodiments shown and described herein;

FIG. 8 depicts a flowchart of an example method for determining a bias status based on multiple user activity, according to one or more embodiments shown and described herein; and

FIG. 9 depicts a flowchart of an example method for determining a bias status based on past user activity, according to one or more embodiments shown and described herein.

### DETAILED DESCRIPTION

The embodiments disclosed herein include systems and methods for detecting and/or ameliorating bias in social multimedia. In embodiments disclosed herein, a system may be embodied in a server that performs methods for detecting and/or ameliorating bias in social multimedia. The server may receive a social media post of a user for detecting bias, where bias may also include reliability. A social media post may be a post from any known social media website including, for example, Facebook, Instagram, Pinterest, Tumblr, and the like, where a post may contain a multimedia and a corresponding text. The multimedia may be any kind of visual including, for example, an image, a video, a graphic, and the like.

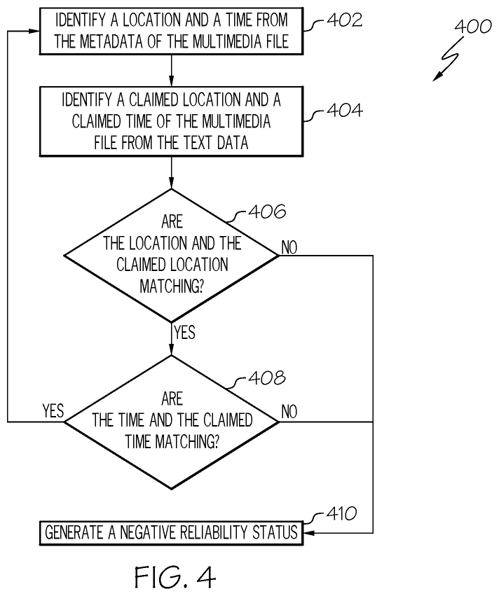

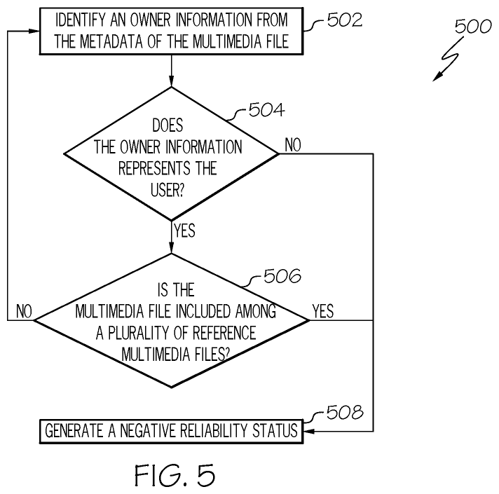

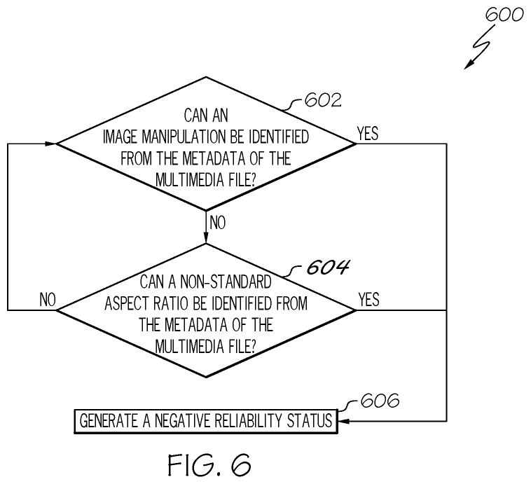

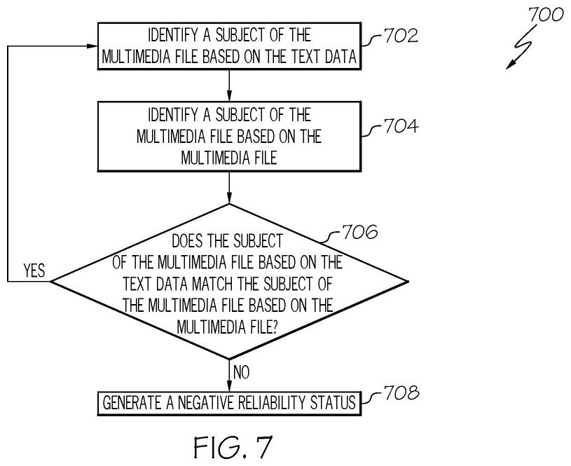

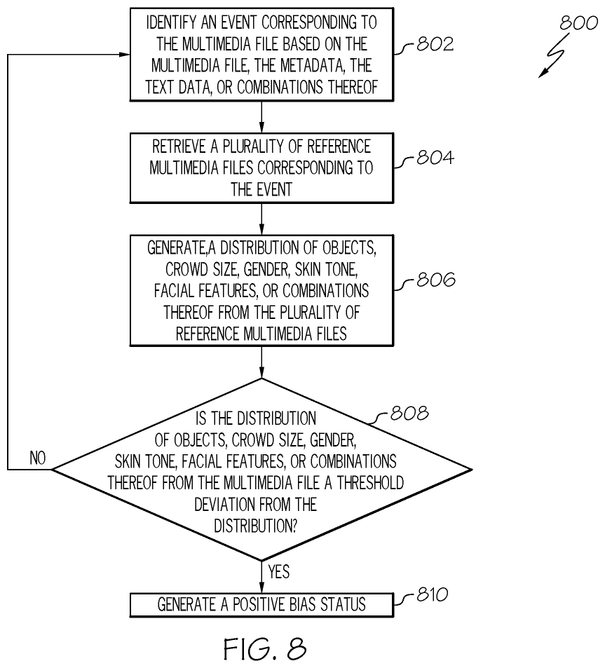

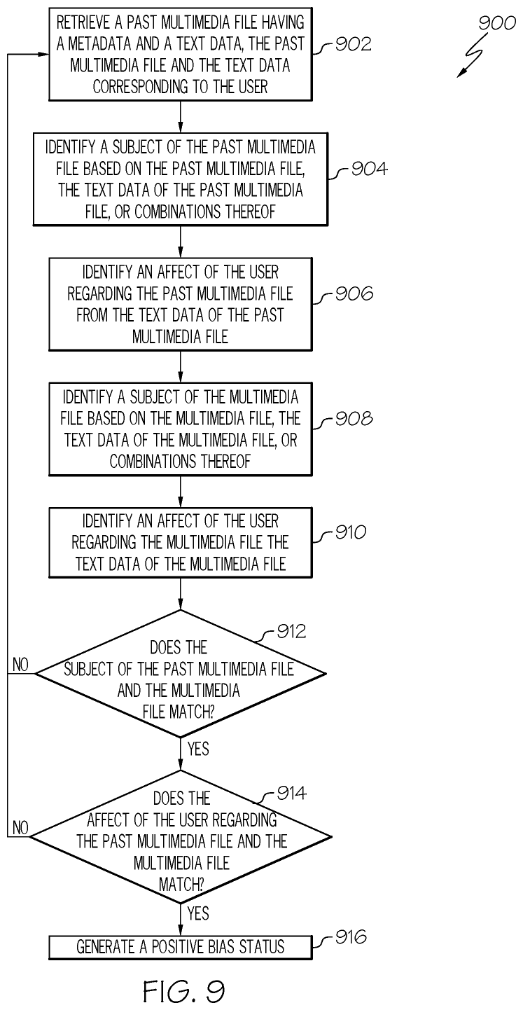

After receiving the social media post, the server may determine a reliability status and a bias status of the social media post. The reliability status is directed to indicating whether the multimedia is an accurate representation of what it appears to present. Reliability status may be determined based on location as shown in FIG. 4, on ownership as shown in FIG. 5, on file manipulation as shown in FIG. 6, and on subject as shown in FIG. 7. The bias status is directed to indicating whether the multimedia is partial to a particular affect of the user. Bias status may be determined based on activity from multiple users as shown in FIG. 8, and past user activity as shown in FIG. 9. Once the reliability status and the bias status have been determined, the server may generate a report of the statuses to assist in ameliorating the bias. Amelioration may occur through, for example, notifying the user and/or viewer of detected bias issues and/or present contextualizing multimedia to the user to counter any detected biases.

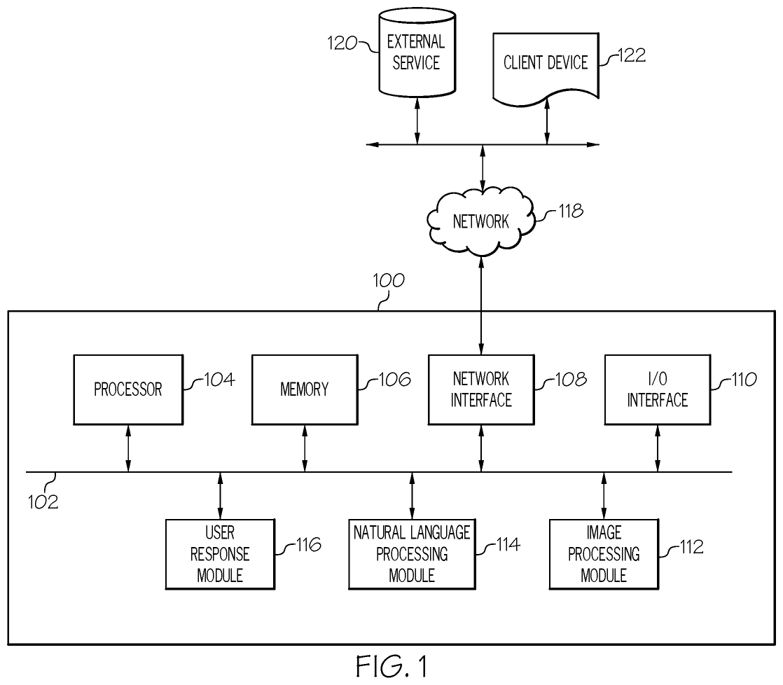

Referring now to FIG. 1, an example system 100 for detecting and ameliorating bias in social multimedia is schematically depicted. The system 100 may include a processor 104, memory 106, input/output (I/O) interface 110, and network interface 108. The system 100 may also include a communication path 102 that communicatively couples the various components of the system 100. The system 100 may be a physical computing device, such as a server. The system 100 may also or instead be a virtual machine existing on a computing device, a program operating on a computing device, or a component of a computing device. The system 100 may be configured to carry out the methods as described herein.

The processor 104 may include one or more processors that may be any device capable of executing machine-readable and executable instructions. Accordingly, each of the one or more processors of the processor 104 may be a controller, an integrated circuit, a microchip, or any other computing device. The processor 104 is coupled to the communication path 102 that provides signal connectivity between the various components of the system 100. Accordingly, the communication path 102 may communicatively couple any number of processors of the processor 104 with one another and allow them to operate in a distributed computing environment. Specifically, each processor may operate as a node that may send and/or receive data. As used herein, the phrase “communicatively coupled” means that coupled components are capable of exchanging data signals with one another such as, e.g., electrical signals via a conductive medium, electromagnetic signals via air, optical signals via optical waveguides, and the like.

The communication path 102 may be formed from any medium that is capable of transmitting a signal such as, e.g., conductive wires, conductive traces, optical waveguides, and the like. In some embodiments, the communication path 102 may facilitate the transmission of wireless signals, such as Wi-Fi, Bluetooth®, Near-Field Communication (NFC), and the like. Moreover, the communication path 102 may be formed from a combination of mediums capable of transmitting signals. In one embodiment, the communication path 102 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical, or electromagnetic), such as DC, AC, sinusoidal-wave, triangular-wave, square-wave, vibration, and the like, capable of traveling through a medium.

The memory 106 is coupled to the communication path 102 and may contain one or more memory modules comprising RAM, ROM, flash memories, hard drives, or any device capable of storing machine-readable and executable instructions such that the machine-readable and executable instructions can be accessed by the processor 104. The machine-readable and executable instructions may comprise logic or algorithms written in any programming language of any generation (e.g., 1GL, 2GL, 3GL, 4GL, or 5GL) such as, e.g., machine language, that may be directly executed by the processor 104, or assembly language, object-oriented languages, scripting languages, microcode, and the like, that may be compiled or assembled into machine-readable and executable instructions and stored on the memory 106. Alternatively, the machine-readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any computer programming language, as pre-programmed hardware elements, or as a combination of hardware and software components.

The input/output interface, or I/O interface 110, is coupled to the communication path 102 and may contain hardware for receiving input and/or providing output. Hardware for receiving input may include devices that send information to the system 100. For example, a keyboard, mouse, scanner, touchscreen, and camera are all I/O devices because they provide input to the system 100. Hardware for providing output may include devices from which data is sent. For example, a monitor, speaker, and printer are all I/O devices because they output data from the system 100.

The network interface 108 includes network connectivity hardware for communicatively coupling the system 100 to the network 118. The network interface 108 can be communicatively coupled to the communication path 102 and can be any device capable of transmitting and/or receiving data via a network 118 or other communication mechanisms. Accordingly, the network interface 108 can include a communication transceiver for sending and/or receiving any wired or wireless communication. For example, the network connectivity hardware of the network interface 108 may include an antenna, a modem, an Ethernet port, a Wi-Fi card, a WiMAX card, a cellular modem, near-field communication hardware, satellite communication hardware, and/or any other wired or wireless hardware for communicating with other networks and/or devices.

The system 100 may be communicatively coupled to a client device 122 and/or an external service 120 by a network 118. The network 118 may be a wide area network, a local area network, a personal area network, a cellular network, a satellite network, an ad hoc network, and the like.

The image processing module 112 is connected to the communication path 102 and contains hardware and/or software for performing image processing on a file of a visual. Image processing may include object detection, image classification, and any other machine-learning-based computer vision technique. For example, the image processing module 112 may include an artificial neural network, having one or more layers, that is trained to recognize one or more features in a multimedia file based on a training data set comprising a plurality of multimedia files labeled as having a feature that the artificial neural network is to recognize. The image processing module 112 may receive as input a multimedia file having a visual, such as an image, a keyframe of a video, and the like. Based on the set of data that the artificial neural network was trained on, the image processing module 112 may output a set of features recognized in the file of the visual. Features may include people, places, objects, image manipulations, and the like. In some embodiments, the NLP module 114 may be stored in the memory 106.

The natural language processing (NLP) module 114 is connected to the communication path 102 and contains hardware and/or software for performing natural language processing on text data. Natural language processing may include word sense disambiguation, named entity recognition, sentiment analysis, and any other machine-learning-based language processing technique. For example, the NLP module 114 may utilize supervised machine learning methods that train a machine learning model based on labeled training sets and uses the trained model to determine whether a word is a keyword, wherein the machine learning model is a decision tree, a Bayes classifier, a support vector machine, a convolutional neural network, or the like. The NLP module 114 may also or instead utilize unsupervised methods that rely on linguistic-based, topic-based, statistics-based, and/or graph-based features of the text data such as text-frequency inverse-document-frequency (TF-IDF), KP-miner, TextRank, Latent Dirichlet Allocation (LDA), and the like. The NLP module 114 may also include pre-processing techniques for making the natural language processing more efficient. For example, the NLP module 114 may include cleaning the text data by changing the text into a uniform case, removing punctuation, removing stop words, stemming, lemmatization, or any other data cleaning techniques. In some embodiments, the NLP module 114 may be stored in the memory 106.

The user response module 116 is connected to the communication path 102 and contains hardware and/or software for generating a predicted user affect towards a visual. To generate a predicted affect, user response module 116 may have an artificial neural network trained based on at least a set of past multimedia files of the user and a set of past text data of the user relating to the set of past multimedia files. Training the user response module 116 allows the user response module 116 to receive a multimedia file as an input and output a prediction of what the user's affect toward multimedia file would be based on the past user affect relating to the set of past multimedia files. In some embodiments, the user response module 116 may be a different kind of model such as a decision tree, a Bayes classifier, a support vector machine, a convolutional neural network, or the like. In some embodiments, the NLP module 114 may be stored in the memory 106.

The external service 120 may be communicatively connected to the system 100 via network 118. The external service 120 may be one or more of any services that are utilized by the system 100. A service may include remote storage, distributed computing, and any other task performed remotely from the system 100 and on behalf of the system 100. For example, an external service may host the social media posts, including multimedia files and text data, of one or more users.

The client device 122 may generally include a processor, memory, network interface, I/O interface, sensors, and communication path. Each client device 122 component is similar in structure and function to its system 100 counterparts, described in detail above and will not be repeated. The client device 122 may be communicatively connected to the system 100 via network 118. The client device 122 may be a user device, and multiple user devices may be communicatively connected to one or more servers via network 118. For example, a client device 122 may be a smartphone, laptop, or any other personal electronic device. The I/O interface of the client device 122 may include a keyboard and mouse for the user to create a social media post by selecting a multimedia to upload as well as type a text data corresponding to the multimedia.

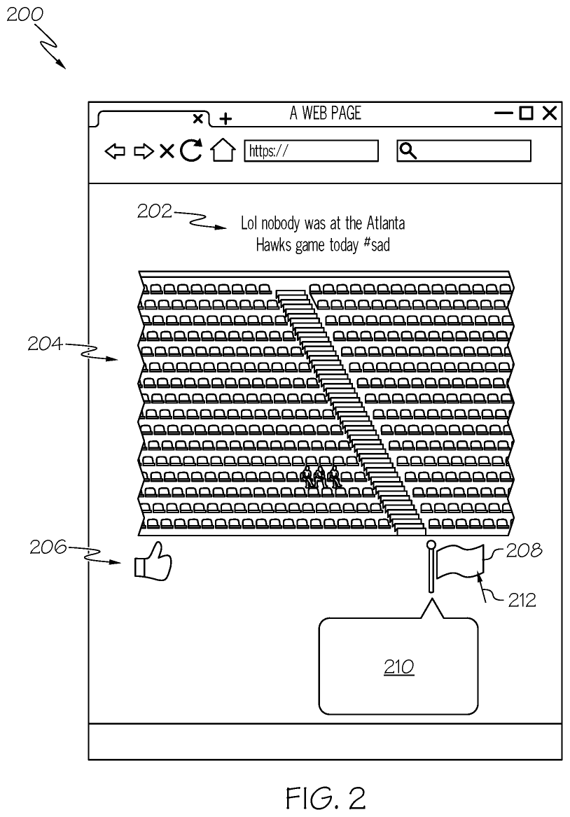

Referring now to FIG. 2, an example user interface 200 of a social multimedia post is depicted. The social multimedia post may include a text data 202 and a multimedia file 204. The text data may be a caption associated with the multimedia file 204. The multimedia file 204 may be an image, a video, a GIF, or any other visual. The system 100 may perform methods described herein to determine a bias of the user. The bias may include a reliability status component and a bias status component, where the reliability status is indicative of whether the multimedia is an accurate representation of what it appears to present and the bias status is indicative of whether the multimedia is partial to a particular affect of the user. The reliability status and/or the bias status may be based on the text data 202, the multimedia file 204, and/or the reaction 206 of one or more social multimedia posts of the user and/or one or more other users. Once the reliability status and the bias status of the social multimedia post have been determined, the system 100 may generate a report 208 comprising the reliability status and the bias status of the multimedia file.

The user interface 200 may be displayed on the client device 122. The user interface 200 may include the text data 202, the multimedia file 204, and/or the reaction 206 of one or more social multimedia posts of the user and/or one or more other users. The system 100 may generate a report 208 comprising the reliability status and the bias status of one or more of the social multimedia posts on the user interface 200. The report 208 may appear as an icon, such as a flag. The icon may have different colors based on the reliability status and/or the bias status. For example, a severely unreliable social multimedia post may have a red flag and a moderately unreliable social multimedia post may have an orange flag. In some embodiments, the icon of the report 208 may have different shapes based on the reliability status and/or the bias status. For example, a reliability status issue may appear as a flag icon and a bias issue may appear as an exclamation mark (T) icon. The report 208 may reveal more detail about the reliability status and/or bias status as well as any measures to ameliorate any reliability and/or bias issues. For example, the user may hover a cursor 212 over the report 208 icon to reveal a notification area 210 that contains therein a plurality of contextualizing images from a variety of sources regarding the same event as the social multimedia post. The contextualizing images may show, for example, that the event described in the text data 202 was completed at the time the multimedia file 204 was captured or that other areas of the event were full of attendees.

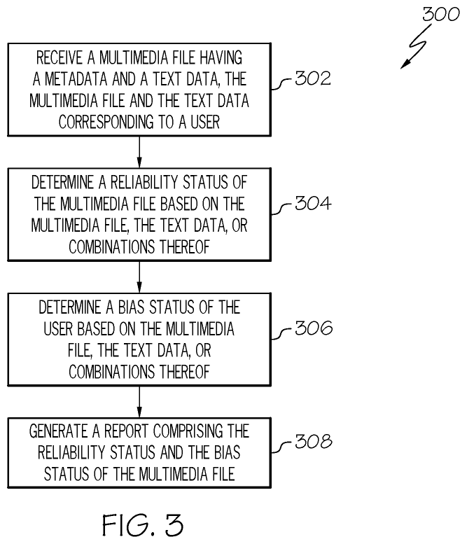

Referring now to FIG. 3, a flowchart of an example method 300 for detecting and ameliorating bias in social multimedia is depicted. At step 302, the system 100 may receive a social multimedia post comprising a multimedia file having a metadata and a text data. The multimedia file and the text data corresponds to a user. The system 100 may be a server that hosts and analyzes the social multimedia posts, a server that analyzes social multimedia posts, a web browser plug-in that analyzes social multimedia posts, a standalone application that analyzes social multimedia posts, and the like. The social multimedia post may be one or more files in any kind of electronic format. For example, the social multimedia post may be in a electronic text format and/or visual format, such as DOCX, JPEG, PDF, HTML, or any other file type capable of storing text and/or visuals.

At step 304, the system 100 may determine a reliability status of the multimedia file based on the multimedia file, the text data, or combinations thereof. The reliability status is directed to indicating whether the multimedia is an accurate representation of what it appears to present. Reliability status may be determined based on location as shown in FIG. 4, on ownership as shown in FIG. 5, on file manipulation as shown in FIG. 6, and on subject as shown in FIG. 7.

At step 306, the system 100 may determine a bias status of the user based on the multimedia file, the text data, or combinations thereof. The bias status is directed to indicating whether the multimedia is partial to a particular affect of the user. Bias status may be determined based on activity from multiple users as shown in FIG. 8, and past user activity as shown in FIG. 9.

At step 308, the system 100 may generate a report comprising the reliability status and the bias status of the multimedia file. The report may be sent to a user, such as via a client device 122. The report may reveal more detail about the reliability status and/or bias status as well as contain any measures to ameliorate any reliability and/or bias issues. Amelioration may occur through, for example, notifying the user and/or viewer that the multimedia file may be misleading and present examples of detected bias issues and/or contextualizing multimedia to the user to counter any detected biases. For example, following the multimedia file may be a report area that contains therein a plurality of contextualizing images from a variety of sources regarding the same event as the social multimedia post to ameliorate any reliability and/or bias issues concerning the multimedia file.

Referring now to FIG. 4, a flowchart of an example method 400 for determining a reliability status based on location is depicted. In step 402, the system 100 identifies a location and a time from the metadata of the multimedia file. The metadata may be found from the platform that the multimedia file is hosted on. For example, a social media platform may have a time stamp and/or location stamp for each multimedia post on the platform. The metadata may also be found in the EXIF information associated with the multimedia file. For example, if the multimedia file is an image, an image capturing device that generated the image likely embedded information onto the image in the form of EXIF information, which may include information such as the time, date, location, device used, device settings used, and other metadata relating to the captured image.

In step 404, the system 100 may identify a claimed location and a claimed time of the multimedia file from the text data. The text data associated with the multimedia file may be analyzed with the NLP module 114. The NLP module 114 may tag components of the text data to identify locations and times within the text data. The NLP module 114 may also or instead extract or infer the names of events from the text data, from which the system 100 may reference an external service 120 (e.g., a directory of nearby events) to identify a location and a time. For example, the NLP module 114 may extract “Atlanta Hawks game” and “today” from text data “nobody was at the Atlanta Hawks game today #sad” and then reference a directory of Atlanta Hawks game to identify the location of the multimedia file on the day the multimedia file was posted.

At step 406, the system 100 determines whether the location of the multimedia file and the claimed location are matching. If the location of the multimedia file as identified by the metadata of the multimedia file does not match the location the NLP module 114 identified from the text data, then the process may move to step 410. Otherwise, the process may move to step 408. In some embodiments, the locations do not have to be identical but may be within a predetermined threshold of a distance apart from one another. For example, when an event spans multiple city blocks, an online directory (e.g., external service 120) of the event may indicate a particular address for the event although there may be multiple appropriate addresses.

At step 408, the system 100 determines whether the time of the multimedia file and the claimed time are matching. If the time of the multimedia file as identified by the metadata of the multimedia file does not match with the time the NLP module 114 identified from the text data, then the process may move to step 410. Otherwise, the process may move to step 402. In some embodiments, the times do not have to be identical but may be within a predetermined threshold distance apart from one another. For example, when an event spans a period of multiple days, an online directory of the event may indicate that it begins at a particular time and lasts for a particular duration although the multimedia file may online indicate a time within the duration.

At step 410, the system 100 generates a negative reliability status. The reliability status may be a binary or non-binary indicator of reliability. For example, if the location and/or the time of the multimedia file is different from the claimed location and/or claimed time, the system 100 may simply generate a negative reliability status to indicate to viewers that the multimedia file is of questionable reliability. The system 100 may also or instead determine a difference between the location and the claimed location of the multimedia file and/or a difference between the time and the claimed time of the multimedia file to determine a degree of unreliability. Then the system 100 may generate a negative reliability status including a degree of unreliability to indicate to viewers that the multimedia file is mildly to severely unreliable, for example. In some embodiments, the negative reliability status includes generating a notice that the multimedia file may not be from the claimed location and/or the claimed time and providing for output the notice on an electronic display for viewers of the multimedia file.

Referring now to FIG. 5, a flowchart of an example method 500 for determining a reliability status based on ownership is depicted. In step 502, the system 100 identifies an owner information from the metadata of the multimedia file. The metadata may be found in the EXIF information associated with the multimedia file. For example, if the multimedia file is an image, an image capturing device that generated the image likely embedded information onto the image in the form of EXIF information, which may include information such as the time, date, location, device used, device settings used, copyright information, and other metadata relating to the captured image.

In step 504, the system 100 determines whether the owner information represents the user. If the owner information does not correspond to the user who posted the multimedia file, then the process may move to step 508. Otherwise, the process may move to step 506. In some embodiments, the owner information and the user may correspond by name, email address, physical address, and any other personally identifiable information.

In step 506, the system 100 determines whether the multimedia file is included among a plurality of reference multimedia files. Reference multimedia files may be multimedia files of the same type as the multimedia file gathered from external services 120 such as stock photo databases, news media databases, and the other databases that would likely indicate that the user is not the original author of the multimedia file. The image processing module 112 may compare the multimedia file with the reference multimedia files by pixels, identified subjects, and/or other features of the multimedia file. If the multimedia file is included among the plurality of reference multimedia files, then the process may move to step 508. Otherwise, the process may move to step 502. In some embodiments, the image processing module 112 may compile a plurality of reference images to train a machine learning module to recognize the multimedia file within any of the reference images. For example, the multimedia file may be only a portion of a published reference multimedia file and the image processing module 112 may recognize the multimedia file as being part of a reference multimedia file. In some embodiments, the image processing module 112 may perform a reverse image search of the multimedia file, where the multimedia file is an image or keyframe of a video.

In step 508, the system 100 generates a negative reliability status. The reliability status may be a binary or non-binary indicator of reliability. For example, if the multimedia file is included within a plurality of reference multimedia files, the system 100 may simply generate a negative reliability status to indicate to viewers that the multimedia file is of questionable reliability. The system 100 may also or instead determine a probability of similarity between the multimedia file and one or more reference multimedia files to determine a degree of unreliability. Then the system 100 may generate a negative reliability status including a degree of unreliability to indicate to viewers that the multimedia file is mildly to severely unreliable, for example. In some embodiments, the negative reliability status includes generating a notice that the multimedia file may not be owned by the user and providing for output the notice on an electronic display for viewers of the multimedia file. In some embodiments, the notice may include the original source of the multimedia file and/or one or more reference multimedia files identified by the image processing module 112.

Referring now to FIG. 6, a flowchart of an example method 600 for determining a reliability status based on file manipulation is depicted. In step 602, the system 100 may determine whether an image manipulation can be identified from the metadata of the multimedia file. Image manipulations may include rotations (e.g., turning an image), transformations (e.g., changing the perspective of the image), splices (e.g., combining parts of two different images), cloning (e.g., copying parts from an image to another part of the image), removals (e.g., removing and filling in an area of an image), and any other visual modifications. Image manipulations may be identified by identifying a watermark of an image manipulation software in multimedia file's metadata. For example, an image's EXIF data may have a “history software agent” category that identifies “Adobe Photoshop” as having modified the image. Image manipulations may also be identified by the image processing module 112. The image processing module 112 may contain an artificial neural network trained with a data set of examples of known, manipulated multimedia files so that it may receive a multimedia file as an input and output an area of the multimedia file that has likely been manipulated. If a potential image manipulation is identified, then the process may move to step 606. Otherwise, the process may move to step 604. It should be noted that image manipulations may also be detected in videos as well where the image manipulations exist in frames of videos.

In step 604, the system 100 may determine whether the multimedia file has a non-standard aspect ratio. A non-standard aspect ratio may be indicative of cropping and/or resizing of an image. Most digital cameras capture photos and videos in 4:3, 3:2, or 16:9 aspect ratios. Other standard aspect ratios include 1:1, 5:4, and 3:1. The system 100 may analyze the metadata of the multimedia file to determine the pixel length and the pixel width of the multimedia file and calculate the aspect ratio therefrom. If the calculated aspect ratio is not a standard aspect ratio, then the process may move to step 606. Otherwise, the process may move to step 604.

In step 606, the system generates a negative reliability status. The reliability status may be a binary or non-binary indicator of reliability. For example, if the multimedia file has a potential image manipulation, the system 100 may simply generate a negative reliability status to indicate to viewers that the multimedia file is of questionable reliability. The system 100 may also or instead determine a probability of image manipulation to determine a degree of unreliability. Then the system 100 may generate a negative reliability status including a degree of unreliability to indicate to viewers that the multimedia file is mildly to severely unreliable, for example. In some embodiments, the negative reliability status includes generating a notice that the multimedia file may have been manipulated by the user and providing for output the notice on an electronic display for viewers of the multimedia file. In some embodiments, the notice may include highlighting portions of the multimedia file of areas where there is likely image manipulation.

Referring now to FIG. 7, a flowchart of an example method 700 for determining a reliability status based on subject is depicted. In step 702, the system 100 may identify a subject of the multimedia file based on the text data. The NLP module 114 may extract a plurality of keywords from the text data. To extract keywords, the NLP module 114 may utilize a keyword extraction model that uses machine learning to break down human language for understanding by machine. Particularly, the keyword extraction model may utilize supervised methods that train a machine learning model based on labeled training sets and utilizes the trained model to determine whether a word is a keyword, wherein the machine learning model is a decision tree, a Bayes classifier, a support vector machine, a convolutional neural network, or the like. The keyword extraction model may also or instead utilize unsupervised methods that rely on linguistic-based, topic-based, statistics-based, and/or graph-based features of the text data, such as text-frequency inverse-document-frequency (TF-IDF), KP-miner, TextRank, Latent Dirichlet Allocation (LDA), and the like. Based on the extracted keywords of the text data a topic may be identified via topic modeling. Topic modeling may be the use of unsupervised machine learning to extract the main topics, as represented by keywords, that occur in a text data. For example, LDA is a type of topic model that is used to classify words in a text data to a particular topic.

In step 704, the system 100 may identify, with the image processing module 112, a subject of the multimedia file based on the multimedia file. The image processing module 112 may include an artificial neural network, having one or more layers, that is trained to recognize one or more features in an image. Features may include people, places, objects, and the like. The output of the image processing module 112 may be one or more words describing one or more features of the image.

In step 706, the system 100 may determine whether the subject of the multimedia file based on the text data does match the subject of the multimedia file based on the multimedia file. The NLP module 114 may determine how similar the subjects are to one another. The subjects may be considered matching if they are within a threshold similarity level. For example, if the subjects are words, the NLP module 114 may assign each subject a word embedding via a pre-trained word embedding model, such as GloVe or Word2Vec. Based on the word embedding, the NLP module 114 may measure a distance between the word embeddings by calculating a similarity value between the embeddings. For example, the NLP module 114 may calculate a word mover's distance or cosine similarity between the word embeddings. If the similarity value is within a predetermined range, the subjects may be considered matching. In some embodiments, instead of determining the subject of the text data at step 702, the image processing module 112 may generate a sentence describing the one or more features of the image at step 704. The sentence and the text data may be compared by generating word embeddings the sentence and the text data, and comparing the word embeddings (e.g., by calculating a Euclidian distance, a cosine similarity, a word mover's distance, or the like). If the similarity value is within a predetermined range, the subjects may be considered matching.

In step 708, the system 100 may generate a negative reliability status. The reliability status may be a binary or non-binary indicator of reliability. For example, if the subject of the text data does not match the contents of the multimedia file, the system 100 may simply generate a negative reliability status to indicate to viewers that the multimedia file is of questionable reliability. The system 100 may also or instead determine a degree of mismatch to determine a degree of unreliability. Then the system 100 may generate a negative reliability status including a degree of unreliability to indicate to viewers that the multimedia file is mildly to severely unreliable, for example. In some embodiments, the negative reliability status includes generating a notice that the multimedia file may not be what the user claims it to be and providing for output the notice on an electronic display for viewers of the multimedia file. In some embodiments, the notice may include the likely subject of the multimedia file based on objects recognized by the image processing module 112.

Referring now to FIG. 8, a flowchart of an example method 800 for determining a bias status based on the user activity of multiple users is depicted. In step 802, the system 100 identifies an event corresponding to the multimedia file based on the multimedia file, the metadata, and/or the text data. An event may be identified based on the time and location of the multimedia file, as determined in steps 402 and 404 of method 400 for example. An event may also be identified based on the subject of the multimedia file and/or the text data, as determined in steps 702 and 704 of method 700, for example. An event may further be identified based on tagging by the user on the social media platform on which the multimedia file is hosted. For example, many social media platforms allow the user to mark a location from which the post is uploaded, attribute hashtags to their post, and other methods of attributing a multimedia file to an event so other social media users may find the multimedia file.

In step 804, the system 100 retrieves a plurality of reference multimedia files corresponding to the event. Reference multimedia files may be multimedia files of the same type and event as the multimedia file that are gathered from external services 120 such as stock photo databases, news media databases, and the other multimedia file databases.

In step 806, the system 100 generates a distribution of features from the plurality of reference multimedia files. The features may include objects, crowd size, gender, skin tone, facial features, and/or any other visual characteristics of the multimedia file. The image processing module 112 may include an artificial neural network, having one or more layers, that is trained to recognize one or more features in a multimedia file based on a training dataset comprising a plurality of multimedia files having a feature that the artificial neural network is to recognize. The image processing module 112 may receive as input a multimedia file including a visual such as an image, a keyframe of a video, or the like. Based on the set of data that the artificial neural network was trained on, the image processing module 112 may output a set of features recognized in the file of the visual. Based on the set of features recognized, the image processing module 112 may calculate a statistical distribution of features recognized. For example, the image processing module 112 may calculate what percentage of the multimedia files contain men and what percentage contain women. The image processing module 112 may also determine how many people were depicted in each multimedia file and calculate a statistical distribution, as well as calculate a distribution for other features such as objects, skin tone, and/or facial features.

In step 808, the system 100 may determine whether the distribution of objects, crowd size, gender, skin tone, and/or facial features is a threshold deviation from the distribution. Because a multimedia file may not contain the precise amount of a particular feature within the calculated distribution of step 806, the system 100 may have a predetermined threshold that the multimedia file may deviate from the distribution to prevent overreporting of potential bias in a multimedia file. For example, assume the distribution calculated in step 806 was the crowd size and the percentage of men and women in the crowd, if the multimedia file at issue has 5% more women for its determined crowd size and the threshold deviation is 3%, then the system 100 may generate a positive bias status in step 810. On the other hand, if the multimedia file at issue has 5% more women for its determined crowd size and the threshold deviation is 7%, then the system 100 may not generate a positive bias status in step 810.

In step 810, the system 100 may generate a positive bias status. The bias status may be a binary or non-binary indicator of bias. For example, if the depiction of an event by the multimedia file differs from a distribution of depictions of the event by a plurality of reference multimedia files, the system 100 may simply generate a positive bias status to indicate to viewers that the multimedia file may be a biased depiction because it over or under represents features that are shown in the other depictions of the event. The system 100 may also or instead determine a degree of deviation to determine a degree of bias. Then the system 100 may generate a positive bias status including a degree of bias to indicate to viewers that the multimedia file is mildly to severely biased, for example. In some embodiments, the positive bias status includes generating a notice that the multimedia file may be over or under representing a particular feature and providing for output the notice on an electronic display for viewers of the multimedia file. In some embodiments, the notice may include one or more multimedia files of the plurality of reference multimedia files to contextualize the image and ameliorate the user's bias.

Referring now to FIG. 9, a flowchart of an example method 900 for determining a bias status based on past user activity is depicted. In step 902, the system 100 retrieves past multimedia files corresponding to the user. Past multimedia files have a metadata and a text data. Retrieving the past multimedia files of the user allows the system 100 to evaluate the past behavior of the user on the social media platform based on the user's past posts.

In step 904, the system 100 identifies a subject of each of the past multimedia files. The subjects may be determined based on the past multimedia file and/or the text data of the past multimedia file. The subject of a past multimedia file may be identified as described in steps 702 and 704 of method 700, above.

In step 906, the system 100 identifies an affect of the user regarding the past multimedia files from the text data of the past multimedia files. The NLP module 114 may be configured to extract affective information associated with natural language concepts. For example, the NLP module 114 may engage in rule-based and/or machine-learning-based approaches. A rule-based approach may classify words in a text data as being positive or negative, for example, and return a positive affect if there are more positive words than negative words or return a negative affect if there are more negative words than positive words. Additionally or alternatively, the NLP module 114 may have an artificial neural network trained to tag a particular input with a particular affect based on a training dataset that contains words that are pre-tagged with their corresponding affect. The NLP module 114 may also or instead have statistical models to classify the words as having a particular affect with statistical models such as naïve Bayes, linear regression, support vector machines, and the like. In some embodiments, the NLP module 114 may go beyond the text data and also factor in user reactions, such as reaction 206, to the multimedia file. For example, a “like” or a “thumbs up” on a multimedia file may indicate a positive affect, whereas an “angry” reaction or a “thumbs down” on a multimedia file may indicate a negative affect.

In step 908, the system 100 identifies a subject of the multimedia files. The subject may be determined based on the multimedia file and/or the text data of the multimedia file. The subject of a multimedia file may be identified as described in steps 702 and 704 of method 700, above.

In step 910, the system 100 identifies an affect of the user regarding the multimedia file from the text data of the multimedia file. The affect may be determined via the approach of step 906.

In step 912, the system 100 determines whether the subject of the past multimedia file and the subject of the multimedia file match. In step 914, the system 100 determines whether the affect of the user regarding the past multimedia file and the affect of the user regarding the multimedia file match. If the subject and the affect match, the process may move to step 916. The subject and the affect matching may indicate that the multimedia file is in furtherance of an existing bias of the user. In some embodiments, the past multimedia files may be used to train an artificial neural network of the user response module 116 to generate a predicted affect of the user. The user response module 116 may receive as input the multimedia file of the user and generate a predicted affect. If the predicted affect of the multimedia file matches the affect of the multimedia file, the process may move to step 916.

In step 916, the system 100 may generate a positive bias status. The bias status may be a binary or non-binary indicator of bias. For example, if the user's affect towards the multimedia file is the same as the user's affect towards past multimedia files, the system 100 may simply generate a positive bias status for the system to retrieve contextualizing multimedia files to ameliorate the bias of the user. The system 100 may also or instead determine a degree that the multimedia file reinforces the user's affect towards the subject of the multimedia file. Then the system 100 may generate a positive bias status including a degree of bias to determine how many contextualizing images to retrieve for the user, for example. In some embodiments, the positive bias status includes generating a notice that the multimedia file is indicative of an ongoing bias of the user and providing for output the notice on an electronic display for the user. In some embodiments, the notice may include one or more multimedia files of the plurality of reference multimedia files to contextualize the image and ameliorate the user's bias.

It should now be understood that the embodiments disclosed herein include systems and methods for detecting and/or ameliorating bias in social multimedia. In embodiments disclosed herein, a system may receive a social media post of a user for detecting bias, where bias may also include reliability. A social media post may contain a multimedia file and a corresponding text, where the multimedia may be any kind of visual including, for example, an image, a video, a graphic, and the like.

After receiving the social media post, the server may determine a reliability status and a bias status of the social media post. Reliability status may be determined based on location, ownership, file manipulation, and subject. Bias status may be determined based on multimedia activity from multiple users, and past user multimedia activity. Once the reliability status and the bias status have been determined, the system may generate a report of the statuses to assist in ameliorating the bias. Amelioration may occur through, for example, notifying the user and/or viewer of detected bias issues and/or present contextualizing multimedia to the user to counter any detected biases.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A system comprising:
a processor;
a memory communicatively coupled to the processor; and
machine-readable instructions stored in the memory that, when executed by the processor, causes the processor to perform operations comprising:
receiving, by an image processing module, a multimedia file having a metadata and a visual data and a text data, the multimedia file and the text data corresponding to a user;
comparing, by the image processing module, the multimedia file and a plurality of reference multimedia files;
determining a reliability status of the multimedia file based on the multimedia file, the text data, or combinations thereof, determining the reliability status comprising:
identifying an owner information from the metadata of the multimedia file;
determining whether the owner information represents the user;
determining, with the image processing module, whether the multimedia file is included among the plurality of reference multimedia files; and
generating a negative reliability status in response to determining that the owner information does not represent the user, the multimedia file is included among the plurality of reference multimedia files, or combinations thereof;
determining a bias status of the user based on the multimedia file, the text data, or combinations thereof; and
generating a report comprising the reliability status and the bias status of the multimedia file.

2. The system of claim 1, wherein determining the reliability status comprises:
identifying a location and a time from the metadata of the multimedia file;
identifying, with a natural language processing module, a claimed location and a claimed time of the multimedia file from the text data;
determining whether the location and the claimed location, and the time and the claimed time are matching; and
generating the negative reliability status in response to determining that the location and the time are different than the claimed location and the claimed time.

3. The system of claim 2, wherein determining the reliability status further comprises:
generating a notice that the multimedia file may not be from the claimed location and the claimed time; and
providing for output the notice on an electronic display.

4. (canceled)

5. The system of claim 1, wherein determining the reliability status further comprises:
generating a notice that the multimedia file may not be owned by the user; and
providing for output the notice on an electronic display.

6. The system of claim 1, wherein determining the reliability status comprises:
determining whether an image manipulation can be identified from the metadata of the multimedia file;
determining whether a non-standard aspect ratio can be identified from the metadata of the multimedia file; and
generating the negative reliability status in response to determining that an image manipulation can be identified from the metadata of the multimedia file, a non-standard aspect ratio can be identified from the metadata of the multimedia file, or combinations thereof.

7. The system of claim 6, wherein determining the reliability status further comprises:
generating a notice that the multimedia file may have been manipulated; and
providing for output the notice on an electronic display.

8. The system of claim 1, wherein determining the reliability status comprises:
identifying, with a natural language processing module, a subject of the multimedia file based on the text data;
identifying, with the image processing module, a subject of the multimedia file based on the multimedia file;
determining whether the subject of the multimedia file based on the text data does not match the subject of the multimedia file based on the multimedia file; and
generating the negative reliability status in response to determining that the subject of the multimedia file based on the text data does not match the subject of the multimedia file based on the multimedia file.

9. The system of claim 1, wherein determining the bias status comprises:
identifying an event corresponding to the multimedia file based on the multimedia file, the metadata, the text data, or combinations thereof;
retrieving a plurality of reference multimedia files corresponding to the event;
generating, with the image processing module, a distribution of objects, crowd size, gender, skin tone, facial features, or combinations thereof from the plurality of reference multimedia files;
determining whether the distribution of objects, crowd size, gender, skin tone, facial features, or combinations thereof from the multimedia file has a threshold deviation from the distribution; and
generating a positive bias status in response to determining that the distribution of objects, crowd size, gender, skin tone, facial features, or combinations thereof from the multimedia file has the threshold deviation from the distribution.

10. The system of claim 1, wherein determining the bias status comprises:
retrieving a past multimedia file having a metadata and a text data, the past multimedia file and the text data corresponding to the user;
identifying, with a natural language processing module, a subject of the past multimedia file based on the past multimedia file, the text data of the past multimedia file, or combinations thereof;
identifying, with the natural language processing module, an affect of the user regarding the past multimedia file from the text data of the past multimedia file;
identifying, with the natural language processing module, a subject of the multimedia file based on the multimedia file, the text data of the multimedia file, or combinations thereof;
identifying, with the natural language processing module, an affect of the user regarding the multimedia file the text data of the multimedia file;
determining, with a user response module, whether the subject of the past multimedia file and the multimedia file match and whether the affect of the user regarding the past multimedia file and the multimedia file match; and
generating a positive bias status in response to determining that the subject of the past multimedia file and the multimedia file match and that the affect of the user regarding the past multimedia file and the multimedia file match.

11. The system of claim 10, wherein determining the bias status further comprises:
identifying a location and a time from the metadata of the multimedia file;
retrieving a contextualizing multimedia file from the location and the time based on the affect of the user regarding the past multimedia file and the multimedia file; and
providing for output, on an electronic display, the contextualizing multimedia file.

12. The system of claim 1, further comprising:
determining whether the report has the negative reliability status, a positive bias status, or combinations thereof; and
generating a notice that the multimedia file may be misleading in response to the report having the negative reliability status, the positive bias status, or combinations thereof.

13. A method comprising:
receiving, by an image processing module, a multimedia file having a metadata and a visual data and a text data, the multimedia file and the text data corresponding to a user;
comparing, by the image processing module, the multimedia file and a plurality of reference multimedia files;
determining a reliability status of the multimedia file based on the multimedia file, the text data, or combinations thereof, determining the reliability status comprising:
identifying an owner information from the metadata of the multimedia file;
determining whether the owner information represents the user;
determining, with the image processing module, whether the multimedia file is included among the plurality of reference multimedia files; and
generating a negative reliability status in response to determining that the owner information does not represent the user, the multimedia file is included among the plurality of reference multimedia files, or combinations thereof;
determining a bias status of the user based on the multimedia file, the text data, or combinations thereof; and
generating a report comprising the reliability status and the bias status of the multimedia file.

14. The method of claim 13, wherein determining the reliability status comprises:
identifying a location and a time from the metadata of the multimedia file;
identifying, with a natural language processing module, a claimed location and a claimed time of the multimedia file from the text data;
determining whether the location and the claimed location, and the time and the claimed time are matching; and
generating the negative reliability status in response to determining that the location and the time are different than the claimed location and the claimed time.

15. (canceled)

16. The method of claim 13, wherein determining the reliability status comprises:
determining whether an image manipulation can be identified from the metadata of the multimedia file;
determining whether a non-standard aspect ratio can be identified from the metadata of the multimedia file; and
generating the negative reliability status in response to determining that an image manipulation can be identified from the metadata of the multimedia file, a non-standard aspect ratio can be identified from the metadata of the multimedia file, or combinations thereof.

17. The method of claim 13, wherein determining the reliability status comprises:
identifying, with a natural language processing module, a subject of the multimedia file based on the text data;
identifying, with the image processing module, a subject of the multimedia file based on the multimedia file;
determining whether the subject of the multimedia file based on the text data does not match the subject of the multimedia file based on the multimedia file; and
generating the negative reliability status in response to determining that the subject of the multimedia file based on the text data does not match the subject of the multimedia file based on the multimedia file.

18. The method of claim 13, wherein determining the bias status comprises:
identifying an event corresponding to the multimedia file based on the multimedia file, the metadata, the text data, or combinations thereof;
retrieving a plurality of reference multimedia files corresponding to the event;
generating, with the image processing module, a distribution of objects, crowd size, gender, skin tone, facial features, or combinations thereof from the plurality of reference multimedia files;
determining whether the distribution of objects, crowd size, gender, skin tone, facial features, or combinations thereof from the multimedia file has a threshold deviation from the distribution; and
generating a positive bias status in response to determining that the distribution of objects, crowd size, gender, skin tone, facial features, or combinations thereof from the multimedia file has the threshold deviation from the distribution.

19. The method of claim 13, wherein determining the bias status comprises:
retrieving a past multimedia file having a metadata and a text data, the past multimedia file and the text data corresponding to the user;
identifying a subject of the past multimedia file based on the past multimedia file, the text data of the past multimedia file, or combinations thereof;
identifying, with a natural language processing module, an affect of the user regarding the past multimedia file from the text data of the past multimedia file;
identifying a subject of the multimedia file based on the multimedia file, the text data of the multimedia file, or combinations thereof;
identifying, with the natural language processing module, an affect of the user regarding the multimedia file the text data of the multimedia file;
determining whether the subject of the past multimedia file and the multimedia file match and whether the affect of the user regarding the past multimedia file and the multimedia file match; and
generating a positive bias status in response to determining that the subject of the past multimedia file and the multimedia file match and that the affect of the user regarding the past multimedia file and the multimedia file match.

20. The method of claim 19, wherein determining the bias status further comprises:
identifying a location and a time from the metadata of the multimedia file;
retrieving a contextualizing multimedia file from the location and the time based on the affect of the user regarding the past multimedia file and the multimedia file; and
providing for output, on an electronic display, the contextualizing multimedia file.

21. A system comprising:
a processor;
a memory communicatively coupled to the processor; and
machine-readable instructions stored in the memory that, when executed by the processor, causes the processor to perform operations comprising:
receiving, by an image processing module, a multimedia file having a metadata and a visual data and a text data, the multimedia file and the text data corresponding to a user;
comparing, by the image processing module, the multimedia file and a plurality of reference multimedia files;
determining a reliability status of the multimedia file based on the multimedia file, the text data, or combinations thereof;
determining a bias status of the user based on the multimedia file, the text data, or combinations thereof, determining the bias status comprising:
identifying an event corresponding to the multimedia file based on the multimedia file, the metadata, the text data, or combinations thereof;
retrieving a plurality of reference multimedia files corresponding to the event;
generating, with the image processing module, a distribution of objects, crowd size, gender, skin tone, facial features, or combinations thereof from the plurality of reference multimedia files;
determining whether the distribution of objects, crowd size, gender, skin tone, facial features, or combinations thereof from the multimedia file has a threshold deviation from the distribution; and
generating a positive bias status in response to determining that the distribution of objects, crowd size, gender, skin tone, facial features, or combinations thereof from the multimedia file has the threshold deviation from the distribution; and
generating a report comprising the reliability status and the bias status of the multimedia file.

22. The system of claim 1, wherein the image processing module contains an artificial neural network.
